(19) United States
(12) Patent Application Publication
(10) Pub. No.: US 2012/0258241 A1
(43) Pub. Date: Oct. 11, 2012

(54) Electrical Contact Material in High-Temperature Electrochemical Devices

(75) Inventors: Michael C. Tucker, Berkeley, CA (US); Lutgard C. DeJonghe, Lafayette, CA (US)

(73) Assignee: The Regents of the University of California, Oakland, CA (US)

(21) Appl. No.: 13/440,231

(22) Filed: Apr. 5, 2012

Related U.S. Application Data
(60) Provisional application No. 61/472,832, filed on Apr. 7, 2011.

(51) Int. Cl. B05D 5/12; H01B 1/08; H01B 1/00

(52) U.S. Cl. 427/77; 252/500; 252/520.5; 252/521.1

(57) ABSTRACT

The feasibility of adding glass to conventional SOFC cathode contact materials in order to improve bonding to adjacent materials in the cell stack is assessed. A variety of candidate glass compositions were added to LSM and SSC. The important properties of the resulting composites, including conductivity, sintering behavior, CTE, and adhesion to LSCF and MCO-coated 441 stainless steel were used as screening parameters. The most promising CCM/glass composites were coated onto MCO-coated 441 stainless steel substrates and subjected to ASR testing at 800° C. In all cases, ASR is found to be acceptable. Indeed, addition of glass is found to improve bonding of the CCM layer without sacrificing acceptable conductivity.

### CROSS REFERENCE TO RELATED APPLICATIONS

This application claims priority to U.S. Provisional Application Ser. No. 61/472,832, filed Apr. 7, 2011 which application is incorporated herein by reference as if fully set forth in its entirety.

### STATEMENT OF GOVERNMENTAL SUPPORT

The invention described and claimed herein was made in part utilizing funds supplied by the U.S. Department of Energy under Contract No. DE-AC02-05CH11231 between the U.S. Department of Energy and the Regents of the University of California for the management and operation of the Lawrence Berkeley National Laboratory. The government has certain rights in this invention.

### BACKGROUND OF THE INVENTION

1. Field of the Invention

The invention pertains to high-temperature electrochemical devices, including solid oxide fuel cells, oxygen purifiers, reversible fuel cells, electrolyzers, electrochemical flow reactors, etc., and more particularly to materials used to electrically and mechanically connect the electrode(s) of the device to the interconnects.

2. Brief Description of the Related Art

High-temperature electrochemical cells, such as solid oxide fuel cells (SOFC) comprise a dense electrolyte disposed between two porous electrodes. A plurality of individual cells may be assembled into a stack. In a stack of planar cells, the cells alternate with a dense interconnect, which electrically connects adjacent cells, while preventing mixing of the anode and cathode reactant streams (in a SOFC, typically air to the cathode and hydrogen or other fuel to the anode) as shown in FIG. 1. The interconnect may also be a current collector, gas flow field, manifold, or mechanical support for a single or multiple cells. The interconnect and cell may be pressed together to create electrical contact, often by means of an external load frame with compression springs or bolts.

It is advantageous to insert a contact material (CM) between the cell and interconnect to improve electrical contact. The contact material is conductive and may be shaped as a felt, mesh, wire, or layer of particles (deposited by aerosol spray, screen printing, brush painting, dip coating, or other standard deposition techniques). The use of such contact materials is well known in the art, and they are variably referred to as contact paste, long-range conductor layer, contact material, etc. Typical choices for the CM on the anode side include paste, felt, or mesh comprising Ni or Pt. These materials tend to bond well to both the anode and interconnect by sintering, mechanical interlocking, or chemical interdiffusion.

Typical choices for the cathode-side CM (hereafter referred to as cathode contact material, CCM), include any of the known SOFC cathode materials, such as LSM (lanthanum strontium manganese oxide), LSCF (lanthanum strontium cobalt iron oxide), LSCM (lanthanum strontium chromium manganese oxide), LC (lanthanum cobalt oxide), LCN (lanthanum copper nickel oxide), etc. See for example U.S. Pat. No. 6,420,064 and U.S. Pat. No. 7,190,568. These materials typically require sintering at high temperature (>1100° C.) to provide effective bonding within the CCM layer and at the CCM/interconnect and CCM/cathode interfaces. The state-of-the-art preferred interconnect material is ferritic stainless steel, primarily chosen for cost and ease of fabrication. Stainless steel interconnects may comprise various functional surface layers, such as Ni, Cu, Co, (Mn,Co)₃O₄, etc. to improve interfacial resistance, reduce oxidation rate, or prevent evaporation of Cr-containing species.

To avoid excessive oxidation of the stainless steel interconnect, heating steps during assembly of the stack must be limited to below 1000° C., with the operation of the fuel cell occurring at no more than 850° C. In practice, this means that significant sintering of the CCM material is difficult to achieve when using stainless steel interconnects. Therefore, the CCM layer is often a loosely-packed bed of conductive particles. This is acceptable if there is suitable external compression to create good mechanical contact between the cathode, CCM, and interconnect. However, uniform compressive loads across the entire area of the cell or stack are rarely achieved in practice. Thermal gradients across the cell area, and thermal transients during stack heat-up and cool-down can cause warping of the cells and interconnects, leading to delamination of the CCM from the cathode or interconnect. Such delamination is accompanied by significant loss of electrical contact between the cell and interconnect.

Efforts to decrease the required sintering temperature through doping and control of defect structure have met with but limited success. What is still needed is an effective CCM that is electrically conductive, and displays improved bonding to the interconnect and/or cathode after processing at about 1000° C. or lower.

### SUMMARY OF THE INVENTION

The invention provides for a cathode contact material (CCM) composition displaying improved bonding after processing at about 1000° C. or lower. The composition can comprise conductive particles, the bonding between these particles to adjacent materials being improved by a bonding aid phase. In one embodiment, the conductive particle composition is selected from the set of known SOFC cathode materials, such as for example LSM (lanthanum strontium manganese oxide), SCC (strontium samarium cobalt oxide), LSCM (lanthanum strontium chromium manganese oxide), LCN (lanthanum copper nickel oxide) and the like, and the bonding aid is either a glass or inorganic binder such, as for example, silicate-based glass, or polyphosphate-based, silicate-based, or aluminosilicate binder.

In one embodiment the bonding aid is a glass composition which is added to the CCM material in a weight range of greater than zero percent to less than 50%. In another embodiment, the glass composition is added in a weight range of greater than 0% to 25%, and in yet another embodiment it is added in the weight range of between 1-10% to 1-20%. As a general matter, it is desirable to use the least amount of bonding aid required to achieve the desired improved bonding, as the presence of the bonding aid tends to lower conductivity.

In one embodiment the mixture of bonding aid and particles of the electrical conductor is applied to a metal member in the form of a wire, mesh, and the like, which metal member is positioned between the cathode and the interconnect. In another embodiment, the mixture of bonding aid and electrical conductor particles is applied as a layer between the cathode and the interconnect with the metal member imbedded within the CCM/bonding aid layer.

### BRIEF DESCRIPTION OF THE DRAWINGS

The foregoing aspects and others will be readily appreciated by the skilled artisan from the following description of illustrative embodiments when read in conjunction with the accompanying drawings.

FIG. 1 (prior art) is a schematic of a fuel cell electrically connected to interconnects by a contact material.

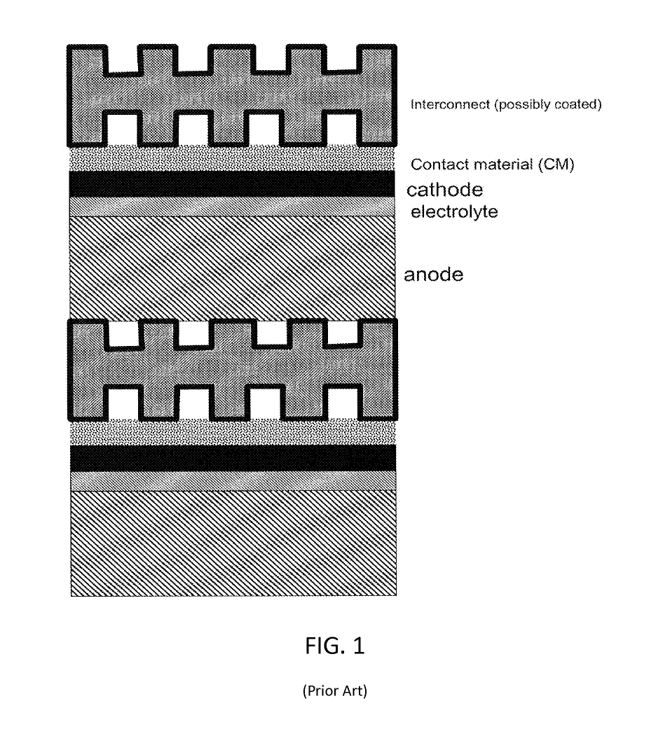

FIG. 2 is a schematic diagram of two embodiments of the present invention.

FIG. 3 is a plot of Area Specific Resistance as a function of time at 800° C. for stainless steel interconnects bonded to LSCF coupons by either LSM-503 or LSM-552 contact materials and for stainless steel interconnect coated with LSM-830 contact material.

FIG. 4 is a plot of room-temperature Vickers Hardness as a function of glass content for LSM/glass composites sintered at 900° C. or 1000° C.

FIG. 5 is a plot of electrical conductivity in air as a function of temperature for various LSM/glass composites sintered at 1000° C.

FIG. 6 is a schematic representation of a specimen geometry used in some of the experiments for CCM deposited on 441 stainless steel that has been coated with (MnCo)₃O₄.

FIG. 7 is a plot of XRD traces for various mixtures of LSM and SPG glass ranging from pure LSM to 50 wt % glass after sintering at 1000° C.

FIG. 8 are SEM images of the fracture surfaces of some of the same LSM/SPG glass mixtures as reported in FIG. 8.

FIG. 9 is a plot of Vickers indentation hardness and shrinkage upon sintering as a function of glass content for various LSM/SPG mixtures.

FIG. 10 is a plot of glass content vs. stud pull test load at failure for a number of LSM-SPG mixtures as applied to MCO-coated 441 steel.

FIG. 11 is a plot of temperature dependency on conductivity for various mixtures of LSM with SPG glass.

FIG. 12 is an XRD plot for sintered LSM mixed with first no glass, 5% Schott D glass and 5% SCN glass.

FIG. 13 is a plot of the electronic conductivity for various mixtures of CCM/glass after sintering at 1000° C., FIG. 13A for LSM/glass, and FIG. 13B for SSC/glass.

FIG. 14 are SEM images of fracture surfaces of LSM/glass mixtures after sintering at 1000° C., where (a) is LSM, (b-c) is LSM-SCZ-8, and (d-e) is LSM/Schott E.

FIG. 15 is a plot of percent linear change at temperature showing the impact of glass addition on the sintering behavior of LSM and SSC.

FIG. 16 is a plot of CTE (coefficient of thermal expansion) for various CCM/glass mixtures.

FIG. 17 is a plot of area-specific resistance (ASR) vs. time for the most promising CCM/glass combinations (with pure CCMs as baseline) applied to MCO-coated 441 stainless steel interconnect coupons, and subjected to 0.5 mA/cm² at 800° C. for 125 h or longer.

FIG. 18 are SEM images of cross-sectioned LSM/Schott E and LSM/SCZ-8 glass specimens after ASR analysis.

### DETAILED DESCRIPTION

The present invention will be described in the context of connecting the electrodes and interconnects of high temperature electrochemical devices such as solid oxide fuel cells, syn-gas generators, oxygen purifiers, and electrolyzers. This does not limit the invention in any way, and applicability to all high-temperature bonding and electrical connection applications is envisioned.

The composition of the invention comprises at least two materials: an electrical conductor and a bonding aid.

### The Electrical Conductor

The electrical conductor phase comprises a particulate material that conducts electrons at the operating temperature of the electrochemical device (typically 500-1000° C.). It is desirable that the electrical conductor is non-volatile, chemically stable in air, and minimally reactive with adjacent materials in the fuel cell stack at the operating temperature. The electrical conductor phase may be a powder, fiber, felt, granule, or other shape. The particles may sinter at the assembly or operation temperature, resulting in a porous or dense conductive bulk material.

In one embodiment, the composition of the particles is selected from the set of known SOFC cathode materials, which are typically mixed transition metal oxides. Suitable materials include but are not limited to:

LSCF (La,Sr)(Co,Fe)O₃₋ₓ

LSCuF (La,Sr)(Cu,Fe)O₃₋ₓ

LSC (La,Sr)CoO₃₋ₓ

SSC (Sm,Sr)CoO₃₋ₓ

SBSC Sm(Sr,Ba)Co₂O₅₋ₓ

GSC (Gd,Sr)Co₂O₅₋ₓ

LSM (La,Sr)MnO₃₋ₓ

LBC (La,Ba)Co₂O₅₋ₓ

YBC (Y,Ba)Co₂O₅₋ₓ

NCC (Nd,Ce)CuO₄₋ₓ

LSCM (La,Sr)(Cr,Mn)O₃₋ₓ

LNF La(Ni,Fe)O₃₋ₓ

LSN (La,Sr)₂NiO₄₋ₓ

LSF (La,Sr)FeO₃₋ₓ

LNC La₂(Ni,Cu)O₄₋ₓ

PNO (Pr,Ni)₃O₄₋ₓ

Particularly useful compositions include LSC and SSC, which display high conductivity at the operating temperature, and LSM and LSCF, which are the most common cathode materials due to their performance and demonstrated stability. The above list is not intended to be restrictive. Many other SOFC cathode compositions are known. In particular, addition of dopants, or variations in stoichiometry of the compositions are well-known. For example, La_{0.65}Sr_{0.35}MnO₃, La_{0.85}Sr_{0.15}MnO₃, and La_{0.8}Sr_{0.2}Ca_{0.1}Mn_{0.9}O₃ are all commonly referred to as “LSM”.

In another embodiment, the electrical conductor is metal, including but not limited to Pt, Au, Ag, Ni, Fe, Cr, Cu, Co, and mixtures and alloys thereof. Because of their low cost and resistance to oxidation at high temperature, Fe—Cr and Ni—Cr alloys such as ferritic stainless steel, Haynes alloys, Hastelloy, Inconel, etc. are particularly suitable.

In yet another embodiment, mixtures of electrical conductor particles or different compositions are used. For example, mixtures of various cathode materials can be employed. The mixed particles may react during processing to create a different composition. In one embodiment, a mixture of oxide particles (such as the cathode materials) and metal particles is used. This is desirable because the metal may be more conductive or less expensive than the oxide particles. If the metal particles are well-coated with the oxide particles, improved oxidation properties of the metal (vs. bare metals) are expected. For example, it is well-known that coating stainless steel with LSM, other cathode materials, or rare earth elements and oxides can reduce oxidation rate and improve scale adhesion.

### The Bonding Aid

Addition of a bonding aid to the electrically conductive material improves bonding within the CCM layer, or at the CCM/interconnect or CCM/cathode interfaces. It is desirable that the bonding aid be non-volatile and stable in air at the operating temperature. It is acceptable for the bonding aid to react to a limited extent with the electronically conducting material, cathode, or interconnect as long as the reaction does not severely reduce the performance of those materials. Limited reaction may in fact be desirable to provide chemical bonding.

Although any level of bonding aid addition is within the scope of the invention, it is desirable to use as little bonding aid as necessary to achieve an improved bond. The bonding aid is not generally expected to be conductive or porous, so addition of too much bonding aid would unnecessarily reduce the conductivity or gas permeability of the CCM. Suitable weight percents of bonding aid in the mixture of bonding aid and electrically conducting particles are 0-50%, 0-25%, or more preferably 1-20%. Generally speaking the optimum amount of bonding aid will vary with the particular material chosen, be it inorganic binder or glass. However, regardless of the type of bonding aid, amounts generally will vary between 2-25 wt %, and more typically for glass between 1-10%, and for inorganic binders between 7-15%.

It should be noted that there is a distinction between the bonding aid compositions of this invention and sintering aid compositions encountered in the art. Sintering aids have been added to cathode materials to improve their densification and strength. Sintering aids generally act by reacting with the surface of the cathode particles to form a new composition that sinters more than the original composition. Various mechanisms are known, but they all act by increasing sintering between particles. In contrast, the mechanism of improvement provided by the compositions of the present invention does not require reaction with the electrically conductive particles. Rather, the bonding aid may remain as a separate phase, coating and adhering particles together. The bonding aid may react with the particles to some extent, but complete reaction is not desirable, nor required for improved bonding to occur.

In one embodiment, the bonding aid is an inorganic binder. Inorganic binders are frequently used in the manufacture of high-temperature adhesives, mortars, plasters, and cements. For example, high-temperature ceramic adhesives typically comprise alumina or zirconia filler particles and an inorganic binder suspended or dissolved in water. The adhesive may be applied as a wet paint or paste, and hardens and cures upon drying or heating. The heating temperature (if any) is much lower than the temperature required to sinter the ceramic filler particles. For example, alumina requires >1500° C. to sinter, but alumina-filled ceramic adhesive can be cured at about 400° C. or below to produce a hard, dense, well-adhered coating or bonding layer. Such adhesives are commercially available from Aremco and Cotronics (exemplary products include 552T, 503T, 644A, 644S, 830, 542, 794, 795, 797). See http://www.aremco.com/wp-content/uploads/2010/11/A11_{—}061.pdf

Various inorganic binder compositions are known in the art, and typically include Ca, Zn, K, Na, Cl, Al, P, or Si, or mixtures of these, and oxygen. The binder functions by crosslinking, polymerization, or curing various polyphosphate, polysialate, polysiloxo, poly(sialate-siloxo), silicate etc. groups. For example, calcium phosphate, calcium aluminate, zinc phosphate, sodium silicate, aluminosilicate, cement, clay, bentonite, Fuller's earth etc. are common constituents of inorganic binder formulations.

In another embodiment, the bonding aid is glass. “Glass” is intended to include vitreous, crystalline, glass-ceramic, and composite types. Whereas many cathode materials require temperatures well above 1000° C. to sinter, a wide range of glass compositions have glass transition points or softening temperatures in the 500-1100° C. range. If the glass wets the electrically conductive particles and the neighboring layers (cathode and interconnect), addition of a small amount of glass to the CCM layer can provide improved bonding. One particularly useful case occurs when the bonding step occurs at a sufficiently high assembly temperature to make the glass viscous or soft, so as to promote wetting and spreading of the glass (generally at about 1000° C. or below), but the operation temperature is sufficiently low that the glass is rigid and resists migration during operation. This is in contrast to the teachings of published patent application US2007/0231676, which provides for a cathode contact composed of a glass matrix containing electrically conductive particles, wherein the resulting composite remains soft and compliant at the operating temperature. The glass may be added to the CCM layer as a powder, frit, granules or other shape of glass; or as a mixture of oxides that will form glass upon heating to the assembly or operation temperature. Preferred glass compositions include those known in the art to be useful as sealing materials for SOFCs. These compositions tend to wet, react minimally with, and have similar coefficient of thermal expansion to common SOFC materials. Various such compositions, including alumino-silicate, boro-silicate, boro-aluminate, and alkali-free compositions, are commercially available and commonly comprise Al, Si, Ca, Ba, B, La, Sr, Mg, or mixtures thereof.

It is known that alkali metals and alkaline earth metals can interact with stainless steel (or other Cr-containing materials) to form volatile compounds containing Cr. The presence of these compounds in the cathode air supply can deposit Cr within the porous cathode, thereby degrading fuel cell performance when using a cathode composition that is not tolerant to the presence of Cr. It is therefore desirable to use a bonding agent composition that does not contain significant amounts of alkali metals and alkaline earth metals (K, Na, Ca, Sr, etc) when used in conjunction with LSM, LSCF, or other cathode materials that are degraded by Cr. Inorganic binders and glasses that are free from these elements are both well known.

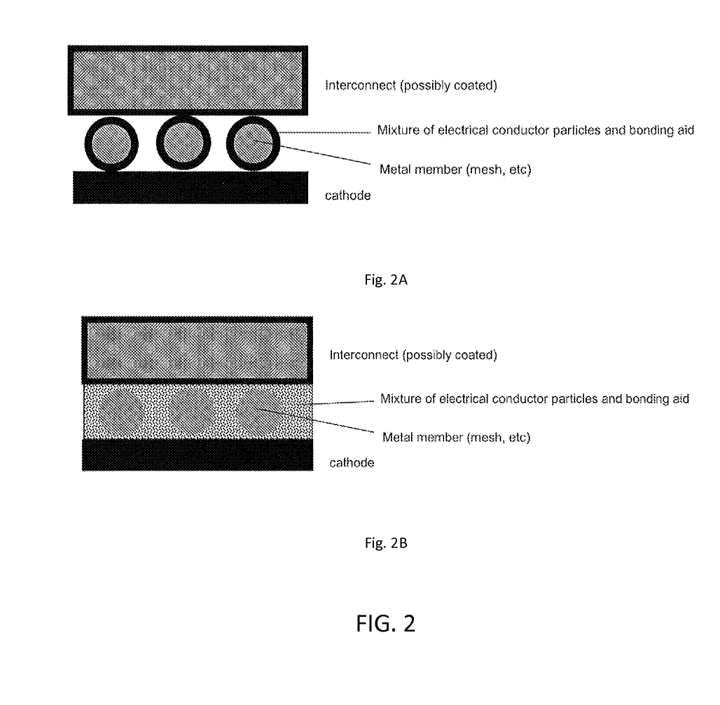

In one embodiment, the CCM additionally comprises a metal member, such as metal fibers, mesh, wire, felt, gauze, foam, etc. The presence of the metal can increase structural integrity and electrical conductivity of the resulting composite. Cost savings are also achieved in the case that the metal is less expensive than the electrical conductor particles. In one embodiment, the metal member is coated with the mixture of electrically conducting particles and bonding aid, as shown in FIG. 2A. The coating can reduce the oxidation rate of the metal member. The mixture of electrical conductor particles and bonding aid may also fill gaps between parts of the metal member (creating a structure similar to concrete with rebar) as shown in FIG. 2B. The metal member may comprise metals including but not limited to Pt, Au, Ag, Ni, Fe, Cr, Cu, Co, and mixtures and alloys thereof. Because of their low cost and resistance to oxidation at high temperature, Fe—Cr and Ni—Cr alloys such as ferritic stainless steel, Haynes alloys, Hastelloy, Inconel, etc. are particularly suitable. The mixture of electrical conductor particles and bonding aid may be applied to the metal member by any suitable means, including but not limited to dip coating, aerosol spray, slurry coating, brush painting, and spin coating.

### EXAMPLES

### Example 1

### Inorganic Binder and Cathode Powder

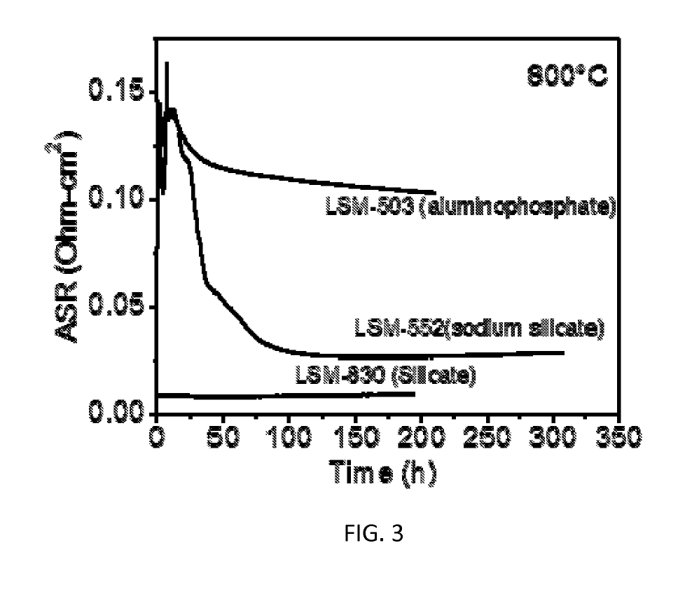

LSM powder (Praxair Specialty Ceramics) was mixed with two different aqueous inorganic binder systems: 552 (sodium silicate, 43 wt % solids, Aremco) and 503 (aluminosilicate, 53 wt % solids, Aremco) to make a CCM paste. In each case, 2.5 g of LSM powder was mixed with 1 g of the aqueous binder system in a planetary mill (Thinky). Thus, after drying and curing, the weight loading of inorganic binder is 17% for LSM/503 and 15% for LSM/552. Sandwiches for area-specific resistance (ASR) testing were prepared by screen-printing the paste onto LSCF and stainless steel coupons (441 coated with (MnCo)₃O₄), and assembling them together in the order Steel/CCM/LSCF/CCM/Steel. The assembled sandwiches were then cured at 360° C., creating a well-bonded specimen. In contrast, sandwiches with LSM only (no inorganic binder) were also fabricated and sintered at 1000° C., but the LSM CCM layer failed easily during handling. Platinum wires were spot-welded onto the steel coupons as electrical leads, and the sandwich was tested with 1A current passing at 800° C. in air. Voltage across the entire sandwich was recorded, and the calculated ASR is shown in FIG. 3. In both cases, after about 50 h of transient behavior, the ASR reaches a low and relatively stable value.

In an alternative configuration, LSM powder (Praxair Specialty Ceramics) was mixed with another aqueous inorganic binder systems: 830 (silicate, 25 wt % solids, Aremco) to make a CCM paste. In this case, 2.0 g of LSM powder was mixed with 0.75 g of the aqueous binder system in a planetary mill (Thinky). Thus, after drying and curing, the weight loading of inorganic binder is 8%. A coated specimen for area-specific resistance (ASR) testing was prepared by screen-printing the paste onto a stainless steel coupon (441 coated with (MnCo)₃O₄). The coated specimen was then cured at 360° C., creating a well-bonded specimen. Platinum wires were spot-welded onto the steel coupons and bonded with Pt paste onto the LSM/830 layer as electrical leads, and the 1 cm×1 cm specimen was tested with 0.5 A current passing at 800° C. in air. Voltage across the entire specimen was recorded, and the calculated ASR is shown in FIG. 3. A low and relatively stable ASR was achieved.,

### Example 2

### Cathode Powder and Glass Bonding Aid

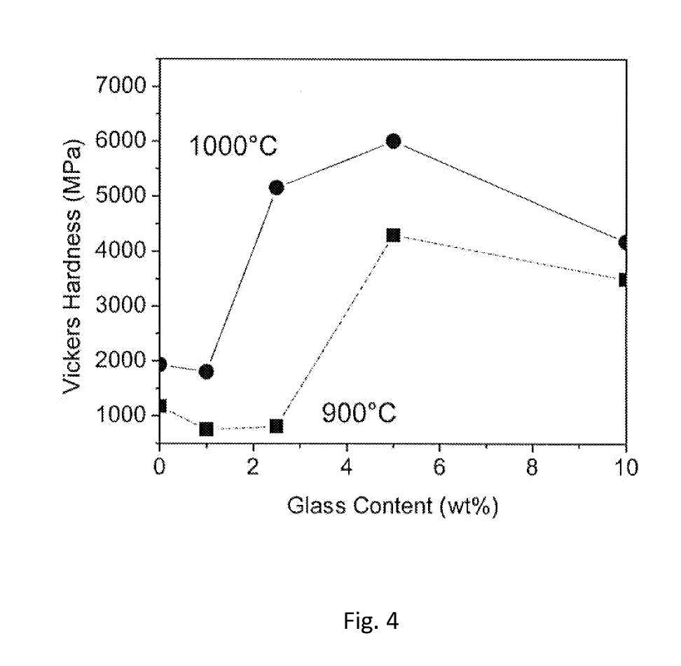

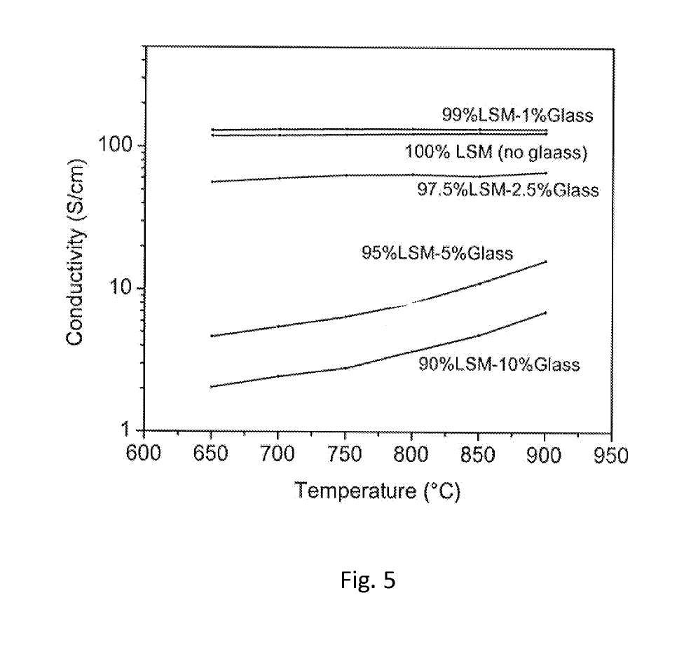

LSM powder (Praxair Specialty Ceramics) was mixed with sodium silicate-based glass-forming powder (Spruce Pine Batch) in various ratios from 1%-10% glass by weight. Pellets of the mixed powder were sintered at 900° C. and 1000° C. in air and tested for Vickers hardness at room temperature (FIG. 4). Addition of 2.5-10% glass dramatically improved the hardness of the LSM/glass composite, indicating improved bonding between the LSM particles. Bars of pure LSM and mixed powder were sintered at 1000° C. in air and tested for conductivity at 650-900° C. in air (FIG. 5). Increasing the glass concentration decreased the conductivity. All samples showed adequate conductivity, however, of >1 S/cm.

### Optimization Studies

In a separate set of experiments, a survey was made to determine which of the many glasses would best serve as the CCM, and at what concentrations performance would be optimized. The important properties of the resulting composites, including conductivity, sintering behavior, CTE, and adhesion to LSCF and MCO-coated 441 stainless steel were used as screening parameters. The most promising CCM/glass composites were then coated onto MCO-coated 441 stainless steel substrates and subjected to ASR testing at 800° C. In all cases, ASR is found to be acceptable. Indeed, addition of glass was found to improve bonding of the CCM layer without sacrificing acceptable conductivity.

The approach taken here was to fabricate composite mixtures of SOFC cathode material and glass, with the goal of preparing a CCM composition that displays improved sintering and bonding via addition of glass, without sacrificing conductivity or long term stability of the resulting mixture.

Initially, a single glass was mixed with LSM in the range 0-50 wt % glass. These mixtures are characterized for conductivity, mechanical properties, and reaction between the LSM and glass. For the optimal mixture ratio, experimentally determined to be around 5 wt %, several commercially-available glasses were then mixed with LSM at this fixed 5 wt % mixture ratio to explore the effect of glass composition. Mixtures with SSC as the cathode composition were also assessed, because the conductivity of SSC is roughly an order of magnitude higher than that of LSM, the results of these tests reported at Table 2.

Finally, the most promising glass/CCM mixtures were applied to MCO-coated 441 steel coupons and tested for area-specific resistance (ASR).

### Experimental Methods

Materials—Powders of LSM and SSC were purchased from Praxair. Glass powders were purchased from Spruce Pine Batch (SPG), SEM-COM (SCN-1 and SCZ-8) and Schott (A: G018-281, B: G018-305, C: G018-337, D: G018-311, E: GM31107).

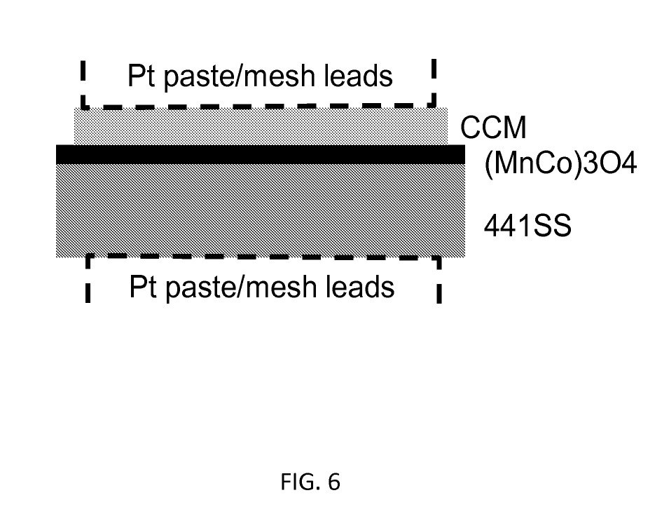

Conductivity—Mixed glass and cathode powder of each composition was ball-milled with binder (PVB(polyvinyl butyral), DBT (dibutyl phthalate), MFO (menhaden fish oil)) in IPA, dried, sieved, and pressed into bars. The bars were sintered at 1000° C. for 1 h in air. The dimensions of the sintered bars were about 1.5×3×40 mm. Pt mesh current leads were applied to the ends of the bars with Pt paste, and Pt wire voltage leads were wrapped around the bar at 0.5 cm to either side of the centerline, as illustrated in FIG. 6. Four-probe DC resistance measurements were taken at 650-900° C. in air using a potentiostat-galvanostat (Biologic VMP-3).

XRD and SEM—XRD (Philips X'Pert) was used to check reaction between glass and LSM or SSC. XRD traces for pure LSM and SSC powder were compared to those for pellets of mixed cathode and glass (as above) after sintering at 1000° C. for 1 h in air.

Fracture surfaces of the sintered mixtures were imaged with SEM and EDS (Hitachi S4300SE/N).

CTE—Small pellets of powder and binder were sintered to 1000° C. for 1 h in air (as above). The sintered pellets were then loaded into a contacting dilatometer (Linseis L75) for CTE measurement from 300-900° C. in air with a heating rate of 3° C./min.

Dilatometry—Small pellets of powder and binder (as above) were sintered in a contacting dilatometer (Linseis L75) in air from room temperature to 1000-1100° C. (depending on powder melting temperature). The heating rate was 3° C./min, followed by a 2 h hold at the maximum temperature. The data presented below in Section 4.2 have been adjusted to remove binder burnout, such that the zero-point occurs at 600° C. (above binder features, and below sintering features).

ASR measurements—Specimens for ASR measurements were prepared according to the geometry in FIG. 6. Various CCM inks were prepared by mixing the powders with Ferro B75717 printing vehicle using a planetary mixer (Thinky). 441 stainless steel coupons were coated with MCO by screenprinting at Pacific Northwest National Laboratory (PNNL). CCM layers were then screenprinted onto the MCO layer, dried at 300° C. and sintered in air at 1000° C. for 1 h. Pt paste (Heraeus CL11-5349) and Pt mesh (Alfa Aesar 10283) were applied as current collectors on the CCM layers, and sintered at 800° C. Pt mesh was spot-welded to the 441 coupon. The ASR specimens were then subjected to 500 mA current for 200 h at 800° C. in air. DC current was applied in a 4-probe configuration using a Biologic VMP3 potentiostat.

Mechanical analysis—Vickers hardness was determined using a Vickers indentation tip loaded with 1 kg dead weight, using a Micromet microhardness tester (Buehler). Interfacial adhesion was assessed using an epoxy-stud pull tester (Quad Group Sebastian V). Glass/CCM inks were printed and sintered onto LSCF and MCO-441 coupons as above.

### Results and Discussion

### LSM-SPG Mixtures

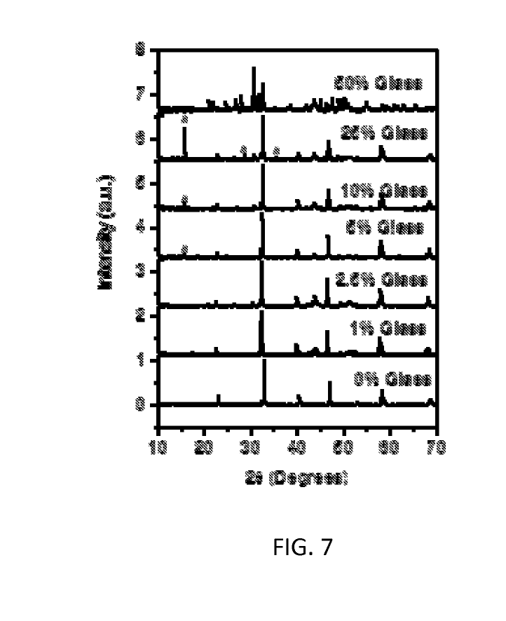

Mixtures of LSM and SPG glass ranging from pure LSM to 50 wt % glass were prepared to assess the general behavior of a well-studied SOFC cathode composition upon addition of glass. FIG. 7 shows XRD traces for various mixtures after sintering at 1000° C. Only peaks corresponding to pure LSM are observed for 0-2.5 wt % glass. A small peak arising from a new phase is observed at 5 wt % loading, and the height of this peak increases with addition of glass up to 25 wt %. The XRD trace for pure glass (not shown) does not contain any peaks, as expected for an amorphous material. Therefore, the new peak is attributed to a reaction product of LSM and glass. At 50 wt % glass loading, nearly all of the LSM is consumed by reaction, and many peaks assigned to reaction products are observed.

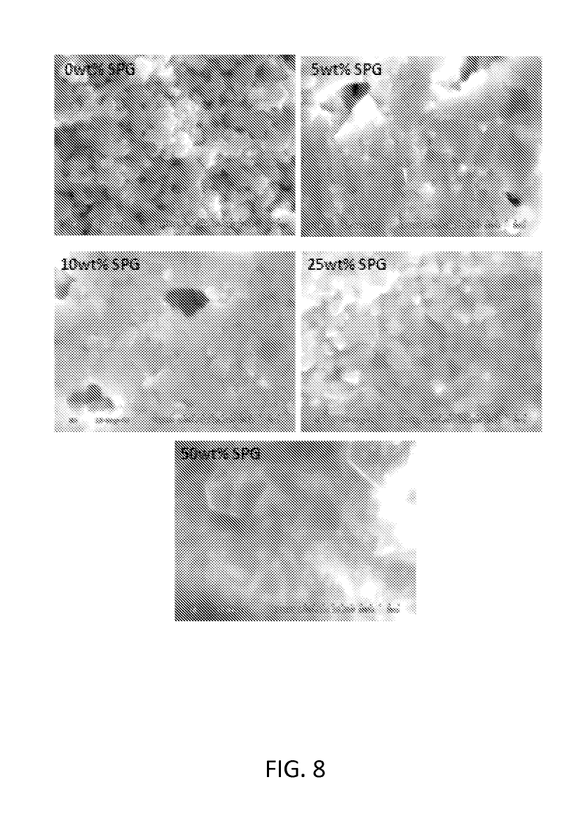

The fracture surfaces of these same mixtures are illustrated in FIG. 8. Pure LSM is minimally sintered after firing to 1000° C., and the morphology is characterized by rough particles with many small pores homogeneously dispersed throughout. The morphology changes dramatically upon addition of 5 wt % glass: the particles are well sintered and although a few large pores are visible, most of the fine porosity is removed. Similar morphology is observed for 10 wt % glass. At 25 wt % glass addition the particles become faceted, suggesting grain growth. At 50 wt % glass, the original LSM particles are not observed; complete modification of the morphology has occurred, yielding needle-shaped crystals in a dense surrounding matrix. This is consistent with the consumption of LSM upon addition of 50 wt % glass observed with XRD above.

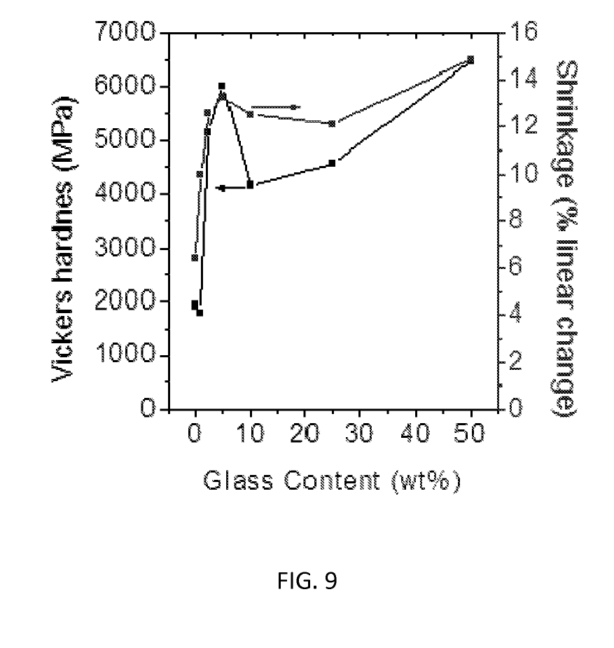

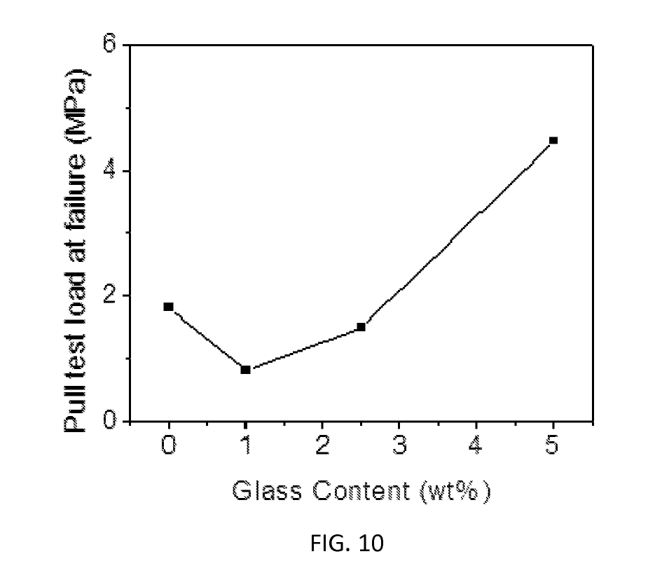

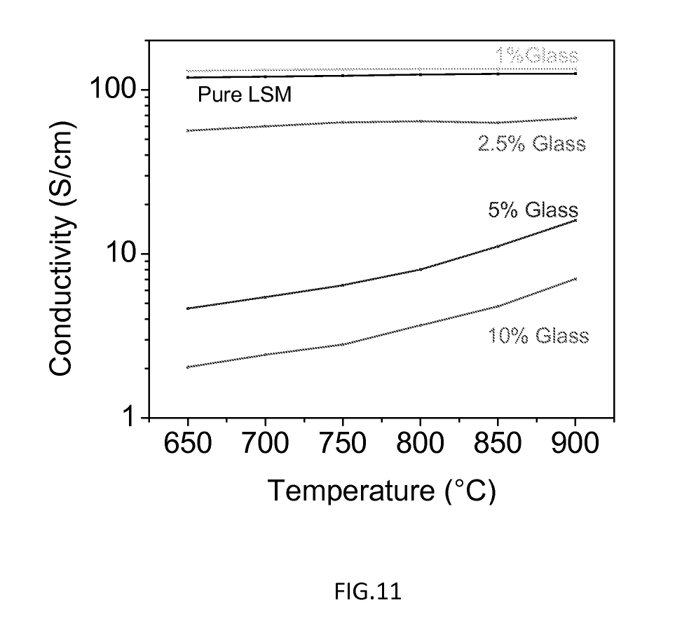

FIGS. 9-11 show physical, mechanical, and electrical properties of the LSM-SPG mixtures. Pellets of LSM-SPG mixtures were sintered at 1000° C. FIG. 9 shows the shrinkage upon sintering and Vickers indentation hardness. Both shrinkage and hardness increase dramatically upon addition of up to 5 wt % glass, and then plateau or even decrease with higher glass content. Adhesion of LSM-SPG mixtures to MCO-coated 441 steel substrate was determined by stud pull test, and shown in FIG. 10. Addition of 5 wt % glass is required before a significant improvement is adhesion is observed. FIG. 11 shows the effect of glass addition on conductivity. In all cases, the conductivity is not a very strong function of temperature. At low glass loading (1 wt % and 2.5 wt %) the conductivity is not significantly compromised. At 5 wt % glass loading, the conductivity is reduced by about an order of magnitude. These observations clearly suggest a trade-off between improved mechanical properties and decreased conductivity upon addition of SPG glass to LSM. At a loading level of 5 wt %, these effects are clearly observed, and higher loading gives rise to significantly reduced conductivity without much gain in mechanical properties. Based on the above, selected was a 5 wt % glass addition as the loading level for comparison of a variety of glass compositions as described below.

### Screening Various Glass Compositions

A variety of glass compositions were selected as candidates to improve the mechanical properties of the cathode contact material. The selected glasses, are marketed as SOFC sealing glasses, and are all silicate-based. They display a wide range of CTE (coefficient of thermal expansion) and softening points as shown in Table 1.

TABLE 1

| | CTE | Softening |
|---|---|---|
| Glass | (ppm/K) | Point (° C.) |
| SPG | 9.6 | 662 |
| SCN-1 | 9.9 | 685 |
| SCZ-8 | 9.5 | 837 |
| Schott A | 4.6 | 927 |
| Schott B | 13.0 | 908 |
| Schott C | 8.1 | 662 |
| Schott D | 9.8 | 770 |
| Schott E | 10.0 | 649 |

Various of these glasses were then mixed with LSM or SSC at 5 wt % glass loading, and screened for shrinkage, conductivity, hardness, and chemical reaction. Glass powders were purchased from SEM-COM (SCN-1 and SCZ-8) and Schott (A: G018-281, B: G018-305, C: G018-337, D: G018-311, E: GM31107). The mixtures were sintered at 1000° C. and assessed for Vickers hardness, reaction between the glass and LSM or SSC, and conductivity at 800° C. as reported in Table 2, below. For many of the glasses tested, the Vickers hardness of the resulting mixture was improved relative to the glass-free material. Addition of SCZ-8 and Schott E glasses resulted in the smallest reduction in conductivity, so these materials were pursued further. Inks containing these glasses and LSM or SSC were printed onto LSCF or (MnCo)₃O₄-coated 441 stainless steel substrates, fired to 1000° C., and tested for adhesion using an epoxy-stud pull test. As shown in Table 2, addition of glass improved bonding of LSM to both substrates, and improved bonding of SSC to LSCF substrate. LSM/glass and SSC/glass mixtures were then applied to coated 441 stainless steel substrates and subjected to 0.5 mA/cm2 at 800 C.

TABLE 2

| | | | | | | Conductivity | Stud pull | Stud pull |
|---|---|---|---|---|---|---|---|---|
| | | | Shrinkage | Vickers | Reaction | at | test on | test on |
| | | | at 1000° C. | Hardness | Observed | 800° C. | LSCF | 441 MCO |
| CCM | Glass | wt % glass | (%) | (MPa) | with XRD | (S/cm) | (MPa) | (MPa) |
| LSM | none | 0 | 6.4 | 1931 | N/A | 124 | 3.9 | 1.8 |
| LSM | SPG | 5 | 13.3 | 6006 | Significant | 8 | | |
| LSM | SCZ-8 | 5 | 8.1 | 2839 | Minimal | 82 | 5.3 | 2.9 |
| LSM | SCN-1 | 5 | 11.1 | 5047 | Significant | 13 | | |
| LSM | Schott A | 5 | 12.7 | 4727 | Significant | 30 | | |
| LSM | Schott B | 5 | 14.4 | 5401 | Minimal | 30 | | |
| LSM | Schott C | 5 | 13.3 | 3929 | Minimal | 61 | | |
| LSM | Schott D | 5 | 14.1 | 5592 | Minimal | 50 | | |
| LSM | Schott E | 5 | 13.7 | 5401 | Minimal | 96 | 4.8 | 3.9 |
| SSC | none | 0 | 15.2 | 4727 | N/A | 1023 | 2.6 | 3.4 |
| SSC | SPG | 5 | 12.8 | 2838 | Significant | 523 | | |
| SSC | SCZ-8 | 5 | 14.3 | 5794 | Minimal | 602 | 5.1 | 2.0 |
| SSC | SCN-1 | 5 | 6.2 | 1283 | Significant | 394 | | |
| SSC | Schott E | 5 | 16.7 | 6006 | Minimal | 613 | 3.2 | 0.9 |

SSC was also chosen as a candidate CCM because it has a much higher conductivity than LSM. A limited number of glass candidates were mixed with SSC. Of the Schott glass candidates, E provided the best conductivity when mixed with LSM, so only this composition was mixed with SSC.

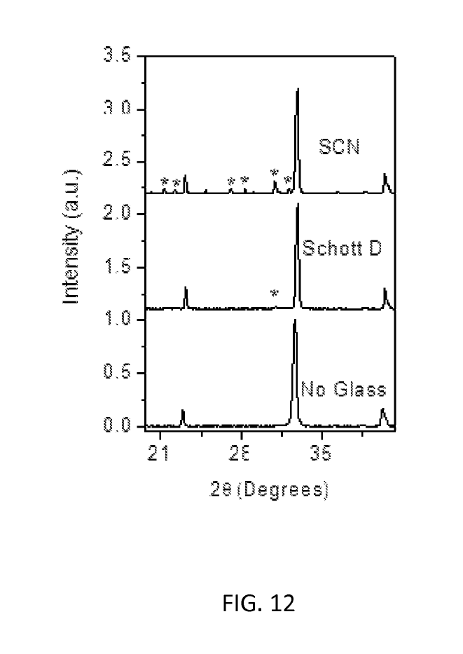

Pellets of all the compositions were sintered to 1000° C., and subjected to Vickers indentation. For LSM, all glasses except for SCZ-8 resulted in significant improvement in shrinkage and hardness. For SSC, addition of SPG and SCN-1 resulted in reduced shrinkage and hardness. Addition of SCZ-8 and Schott E to SSC had minimal effect on shrinkage and moderately improved hardness. XRD was used to determine if reaction between the glass and CCM had occurred during firing at 1000° C., the results of representative XRD traces plotted in FIG. 12. For the case of LSM/Schott D, a single small peak assigned to reaction product is observed, suggesting minimal reaction. For the case of LSM/SCN-1, several larger peaks assigned to reaction products are observed, suggesting significant reaction.

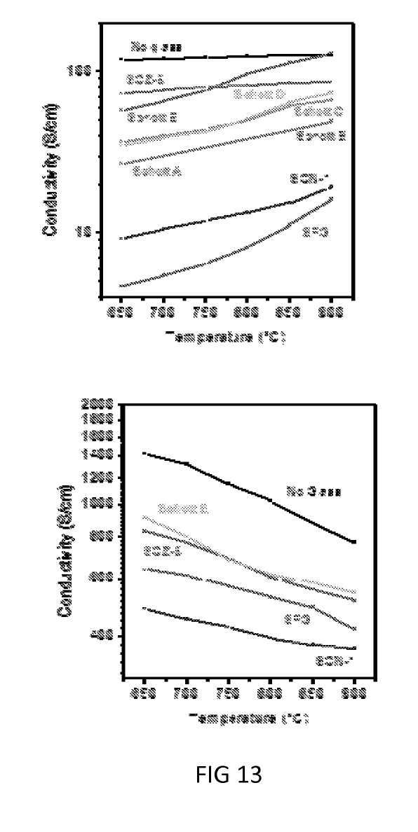

FIG. 13 shows the electronic conductivity for all mixtures after sintering at 1000° C., and more particularly FIG. 13A for LSM/glass, and FIG. 13B for SSC/glass. In all cases, addition of glass reduces the conductivity. Possible mechanisms include reaction with the CCM, or migration of glass into the electronic percolation path between CCM particles. The general trends with temperature are consistent with those for pure LSM or SSC, suggesting that addition of glass does not significantly alter the mechanism of electronic conduction. For both LSM and SSC, addition of SCZ-8 and Schott E glasses reduced the conductivity less than 50%. SPG addition to SSC also fulfilled this criterion. Addition of other glass compositions reduced the conductivity significantly more.

Based on the screening properties summarized in Table 2, chosen was SCZ-8 and Schott E as the most promising glass compositions for further testing and development. Both of these imparted improved hardness without causing significant reaction, nor reducing the conductivity by more than 50%.

Properties of most Promising Compositions

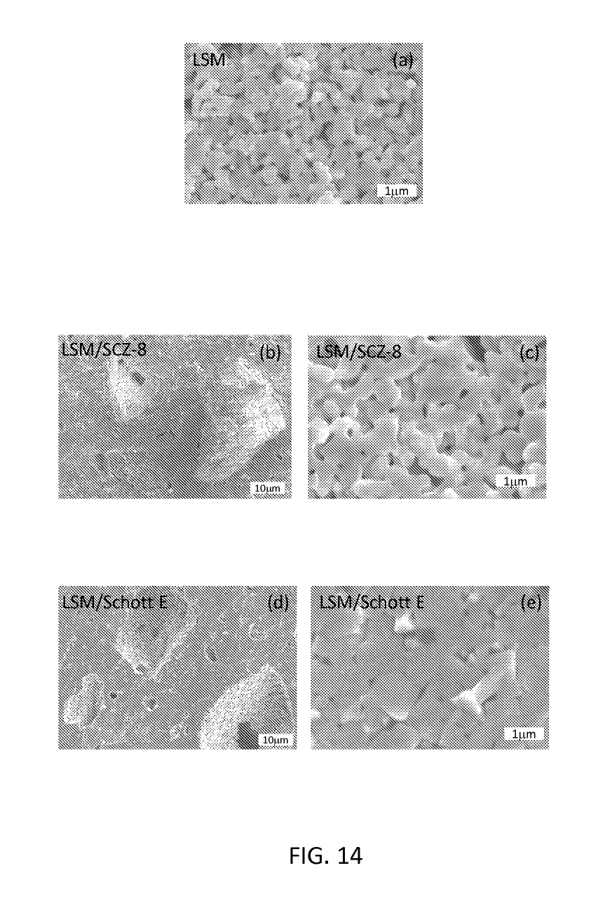

Fracture surfaces of LSM/glass mixtures after sintering at 1000° C. are depicted in FIG. 14. The microstructure of pure LSM is characterized by sub-micrometer individual particles, with significant porosity uniformly dispersed throughout. This is typical for a minimally-sintered ceramic powder compact. The microstructure of the LSM/SCZ-8 mixture is similar, although the particles are larger and noticeably more sintered. In the low-magnification image, it is clear that much of the glass remains intact after sintering. Two sharp-edged 20-30 μm particles of glass, surrounded by LSM particles are seen in the image. This particle size corresponds with that of the as-received glass powder. The microstructure for LSM/Schott E is quite different. Similar sharp-edged features are observed in the low-magnification image, however they are empty. This suggests the glass has moved from its original location into the surrounding LSM matrix, presumably by capillary action. The microstructure of the LSM particles away from the glass particles is significantly denser and more completely sintered than for pure LSM, again suggesting significant interaction of the glass with LSM throughout the whole mixture. Note that the softening temperature of Schott E is almost 200° C. lower than that of SCZ-8 (Table 1), consistent with the observed mobility of Schott E during sintering. The same general features were observed for SSC/SCZ-8 and SSC/Schott E mixtures, although the images are not shown for space considerations.

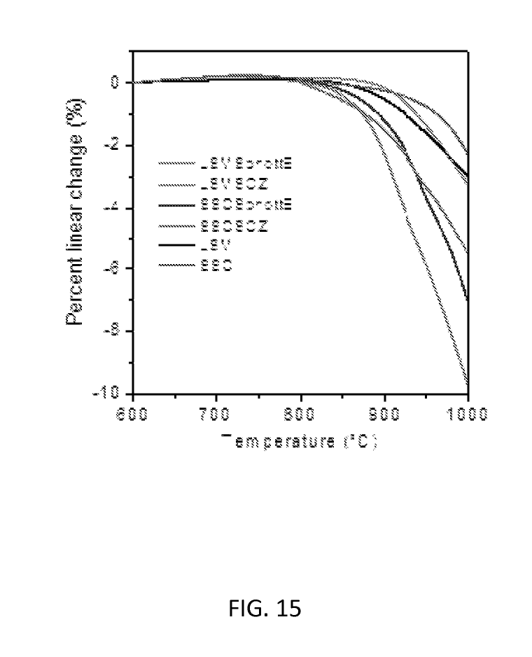

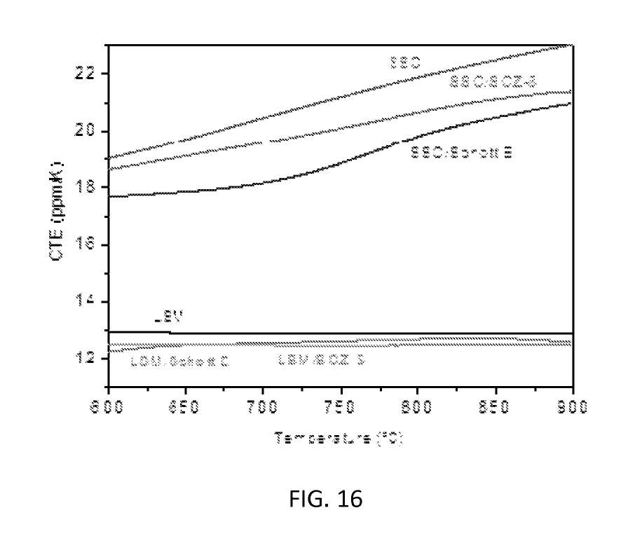

The impact of glass addition on the sintering behavior of LSM and SSC is shown in FIG. 15. In both cases, addition of SCZ-8 moderately increases sintering and Schott E dramatically increases sintering. This is consistent with the microstructural observations above, as well as with the large improvement in Vickers hardness upon addition of Schott E glass. The large change in sintering behavior upon addition of only 5 wt % (2.9 v %) Schott E to either LSM or SSC suggests the glass is acting as a sintering aid. If the glass were only melting and filling some of the pore space of the ceramic matrix, such a large shrinkage would not be expected. Clearly, the composition of the glass has a strong effect on its effectiveness as a sintering aid. The CTE (coefficient of thermal expansion) of pre-sintered pellets of CCM/glass mixtures is shown in FIG. 16. For both LSM and SSC, addition of glass reduces the CTE, improving the CTE match to other cell materials including YSZ (yttria-stabilized zirconia).

Shrinkage and Vickers hardness were expedient screening parameters for down-selecting the most promising glass candidates, but those tests do not directly assess whether the addition of glass to the CCM improves adhesion to the LSCF cathode or MCO interconnect coating. Therefore, pull tests were performed with the most promising CCM/glass mixtures. The CCM/glass mixtures were screen-printed and sintered onto MCO-coated 441 steel coupons and porous LSCF layers (pre sintered on dense LSCF coupons). Epoxy-coated studs were used to assess adhesion of the CCM/glass layer to the substrates. In all cases, failure occurred within the CCM/glass layer or at the interface to the substrate (as opposed to within the substrate). The results are reported in Table 2. For LSM, addition of both SCZ-8 and Schott E improved adhesion to both LSCF and MCO. For SSC, adhesion to LSCF was improved, but both glasses reduced adhesion to MCO. It is not clear why this is the case, although we note that the large CTE difference between SSC (˜21 ppm/K) and 441 stainless steel (˜13 ppm/K) may be a factor. These pull test results clearly indicate that addition of glass to the CCM can be an effective strategy to improve the adhesion to neighboring materials at room temperature. Future work will determine if the improved adhesion persists at the 800° C. operating temperature.

ASR Results for most Promising Compositions

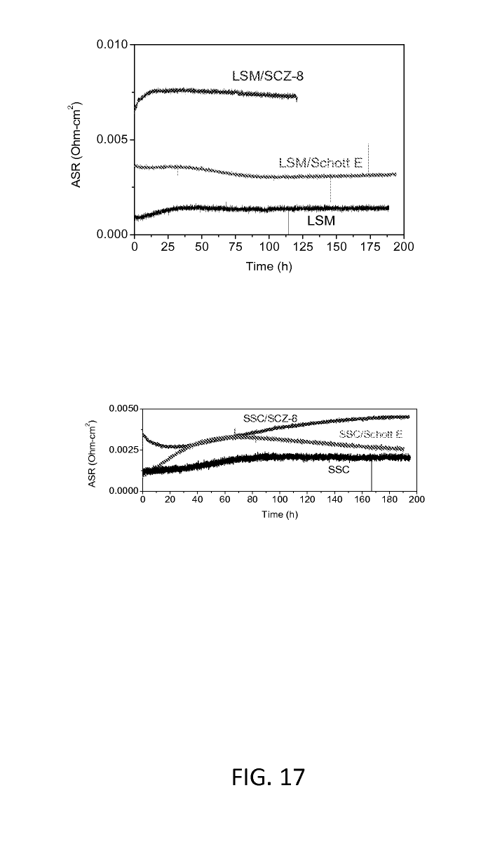

The most promising CCM/glass combinations (and pure CCMs as baseline) were applied to MCO-coated 441 stainless steel interconnect coupons and assessed for area-specific resistance (ASR). The specimens were subjected to 0.5 mA/cm² at 800° C. for 125 h or longer, and the results for LSM/SCZ-8 shown in FIG. 17a, and SSC/SCZ-8 shown in FIG. 17b. Both pure LSM and SSC displayed a relatively low initial ASR, which roughly doubled over the first 75 h of testing and then became stable. Addition of both glasses to LSM caused an increase in initial ASR, but did not adversely affect stability after the initial 25 h of transient behavior.

The increase in ASR upon addition of glass is larger than would be predicted by the increase in conductivity for the bulk materials (FIG. 13 and Table 2). It is unclear why this is the case. Reaction of the glass with the substrate is ruled out by the EDAX analysis below. The discrepancy may arise from difference in the microstructure of the bulk and thin layer CCM/glass mixtures for the following two reasons. The bulk material shrinks significantly upon sintering, whereas the thin layer applied to MCO-441 substrate is constrained during sintering. Also, the bulk material was mixed by ball mill so relatively large glass particles remain intact. In contrast, the thin layer ink was mixed in a planetary mill, so reduction of the glass particle size and therefore improved dispersion of the glass throughout the mixture is expected. For SSC, addition of glass caused a relatively small increase in initial ASR, but the ASR was somewhat less stable than for pure SSC or the LSM/glass combinations. Note that even the highest ASR recorded, for LSM/SCZ-8, is deemed acceptable because it is much lower than the ASR expected for an operating SOFC.

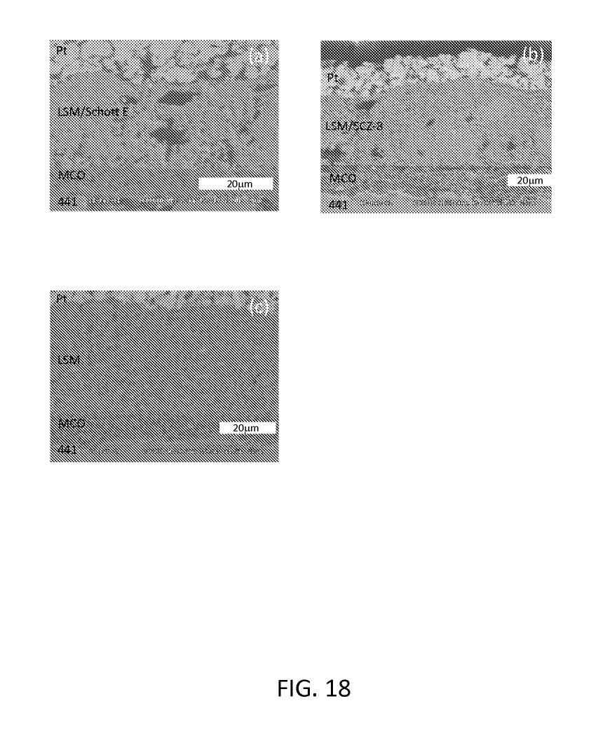

After ASR testing, the specimens were cross-sectioned and analyzed with SEM/EDAX. Representative results are shown in FIG. 18. In all cases, good bonding and a crisp transition at the CCM/MCO interface is observed. For the layers with glass, small voids are visible, presumably arising from glass particles as observed above in FIG. 10. The cross-sections of specimens with SSC (not shown) were similar. EDAX analysis (energy dispersive analysis by x-ray) was used to determine the extent of interdiffusion between the CCM/glass and MCO layers. In all cases, no significant interdiffusion was observed. The results for LSM/SCZ-8 (the composition showing the highest ASR) are shown in FIG. 14. No interdiffusion is observed for Co, La, Sr, Ca, Ba, or Al. Note that the EDAX peaks for Si and Sr overlap, but neither is observed in the MCO layer.

In summary, the feasibility of adding glass to conventional CCM materials in order to improve bonding has been assessed. The composition of the glass plays a significant role in the quality of the resulting composite. Many glasses reacted with the CCM or reduced the conductivity of the CCM/glass composite to an unacceptably low level. The glasses SCZ-8 and Schott E reduced the conductivity minimally, and so were pursued further. Addition of both glasses to LSM improved adhesion to LSCF and MCO-441 substrates. Addition of both glasses to SSC improved adhesion to LSCF substrate, but not to MCO-441. The ASR of CCM/glass composite layers was moderately higher than that of pure CCM materials. Based on these results, it has been found that addition of glass to the CCM is an effective strategy to improve bonding and mechanical properties of the resulting CCM/glass composite, without sacrificing acceptable conductivity. Addition of Schott E glass to LSM was a particularly satisfying example; adhesion strength was significantly improved, while maintaining a low and stable ASR.

Although the foregoing invention has been described in some detail for purposes of clarity of understanding, it will be apparent that certain changes and modifications may be practiced within the scope of the appended claims. In particular, while the invention is primarily described with reference to solid oxide fuel cells, and other electrochemical devices, such as oxygen generators, electrolyzers, or electrochemical flow reactors, etc. Other applications for the compositions displaying bonding and electrical conductivity in accordance with the present invention will be apparent to those of skill in the art. It should be noted that there are many alternative ways of implementing the composition of the present invention. Accordingly, the present embodiments are to be considered as illustrative and not restrictive, and the invention is not to be limited to the details given herein.

This invention has been described herein in considerable detail to provide those skilled in the art with information relevant to apply the novel principles and to construct and use such specialized components as are required. However, it is to be understood that the invention can be carried out by different equipment, materials and devices, and that various modifications, both as to the equipment and operating procedures, can be accomplished without departing from the scope of the invention itself.

We claim:

1. A method comprises the steps of:
a) mixing an electrically conductive material with a bonding aid to form a mixture
b) applying the mixture so that it contacts an electrode of a high temperature electrochemical device and an interconnect, and optionally a metal member; and, thereafter
c) drying, curing or firing the combined materials to bond the mixture to the electrode and interconnect.

2. The method of claim 1 wherein the bonding aid is an inorganic binder.

3. The method of claim 2 wherein the inorganic binder comprises a silicate, an aluminate or a phosphate.

4. The method of claim 2 wherein the inorganic binder is selected from the group comprising Aremco 5031, 552T, 644A, 830, or 542.

5. The method of claim 2 wherein the drying, curing or firing of the combined materials is carried out at about 400° C. or below.

6. The method of claim 1 wherein the bonding aid is a glass.

7. The method of claim 6 wherein the drying, curing or firing of the combined materials is carried out at 1000° C. or below.

8. The method of claim 6 wherein the glass is selected from the group comprising SEM COM SCZ-8 and Schott E

9. The method of claim 1 wherein the conductive material is an electrode material.

10. The method of claim 8 wherein the conductive material is an electrode material used for solid oxide fuel cells.

11. the method of claim 8 wherein the conductive material is selected from the group comprising LSM, LSCF, LSCuF, LSC, SSC, SBSC, GSC, LBC, YBC, NCC, LSCM, LNF, LSN, LSF, LNC, and PNO.

12. The method of claim 6 wherein the conductive material is in the form of a powder.

13. A cathode contact material comprising a mixture of a conductive material and glass.

14. The cathode contact material of claim 13 wherein the glass comprises from 0-50 wt % of the mixture.

15. The cathode contact material of claim 13 wherein the glass comprises from 0-25 wt % of the mixture

16. The cathode contact material of claim 12 wherein the glass composition comprises 1-10 wt % of the mixture.

17. The cathode contact material of claim 13 wherein the glass composition comprises about 5 wt % of the mixture,

18. The cathode contact material of claim 13 wherein the glass is selected from the group comprising SEM-COM SCZ-8 and Schott E glass.

19. A cathode contact material comprising a mixture of a conductive material and inorganic binder.

20. The cathode contact material of claim 19 wherein the inorganic binder comprises from 0-50 wt % of the mixture.

21. The cathode contact material of claim 19 wherein the inorganic binder comprises from 1-25 wt % of the mixture

22. The cathode contact material of claim 19 wherein the inorganic binder composition comprises 7-15 wt % of the mixture,

23. The cathode contact material of claim 19 wherein the inorganic binder comprises a phosphate, an aluminate or a silicate.

24. The cathode contact material of claim 19 wherein the inorganic binder is selected from the group comprising Aremco 503T, 552T, 644A, 830, or 542.

25. The cathode contact material of either claim 13 or claim 19 wherein the conductive material is a cathode material selected from the group comprising LSM, LSCF, LSCuF, LSC, SSC, SBSC, GSC, LBC, YBC, NCC, LSCM, LNF, LSN, LSF, LNC, and PNO.

26. The cathode contact material of claim 13 or claim 19 wherein the glass or inorganic binder does not comprise significant amounts of alkali elements.
